(19) United States
(12) Patent Application Publication
(10) Pub. No.: US 2026/0279211 A1
(43) Pub. Date: Sep. 17, 2026

(54) KIT AND METHOD OF USING THE KIT FOR FACILITATING CORRECT PRONUNCIATION OF WORDS AND/OR LETTERS

(71) Applicant: KING FAISAL UNIVERSITY, HOFOUF (SA)

(72) Inventor: ABDULLAH AMER ALAMER, HOFOUF (SA)

(21) Appl. No.: 19/080,127

(22) Filed: Mar. 14, 2025

(51) Int. Cl. G09B 5/02; G06F 3/0488; G09B 5/06; G10L 15/25

(52) U.S. Cl. CPC G09B 5/02; G09B 5/06; G10L 15/25; G06F 3/0488

(57) ABSTRACT

A method of using a kit includes placing at least one sensor detector on at least one mouth part of the user; pronouncing each of at least one letter and/or each of at least one word by the user; a first detection step of detecting each of at least one motion of each of the at least one mouth part via each of the at least one sensor detector; a first determination step of determining if the detected each of the at least one motion of each of the at least one mouth part correspond to each of at least one predetermined correct motion of each of the at least one mouth part; and displaying the detected each of the at least one motion of each of the at least one mouth part in real-time on a touch screen display interface.

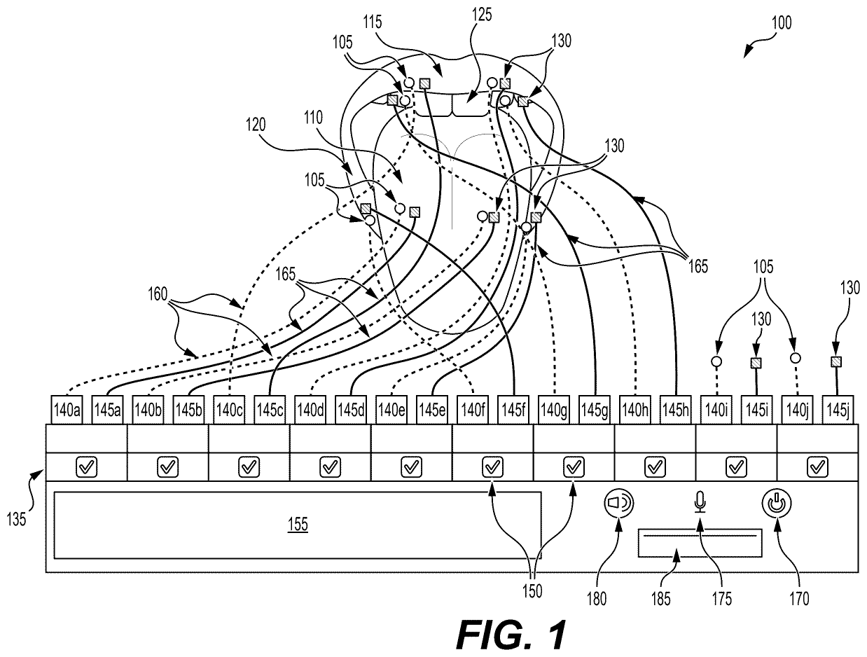

### FIELD AND BACKGROUND

The disclosure of the present application relates to a kit, and particularly to a kit and a method of using the kit for facilitating correct pronunciation of at least one letter and/or at least one word for a particular language.

### DESCRIPTION OF RELATED ART

Speech involves moving the tongue, upper lip, lower lip, jaw, upper teeth, and lower teeth to create sounds (i.e., words and/or letters). These movements are called oral motor skills. The oral motor skills help shape the airflow and vocal cord vibrations that produce sounds. Different speech sounds require different mouth movements, which is why a person's mouth parts (i.e., tongue, upper lip, lower lip, jaw, upper teeth, and/or lower teeth) change positions while they speak. For example, the tongue must change shape and/or contact various landmarks within the oral cavity, often in a precise sequence of movements. The combination of these movements creates the variety of speech sounds we hear and use in various languages.

Many people, particularly those learning a new language, may struggle to produce the precise sequence of movements required for a specific speech sound. For these individuals, inaccurate movements may result in distorted speech sounds that affect the overall intelligibility of their speech.

In light of the above, a need remains for a kit and a method of using the kit for facilitating correct pronunciation of at least one letter and/or at least one word for a particular language.

### SUMMARY

The present subject matter relates to a kit which, in one embodiment, includes at least one sensor detector which can be configured to be placed on at least one mouth part of a user; and a language training device which can include: at least one sensor inlet port, wherein each of the at least one sensor inlet port can be in communication with one of each of the at least one sensor detector, respectively; a controller which can be in communication with each of the at least one sensor detector via each of the at least one respective sensor inlet port, wherein the controller can be configured to detect each of at least one motion of each of the at least one mouth part via each of the at least one sensor detector and determine if the detected each of the at least one motion of each of the at least one mouth part correspond to each of at least one predetermined correct motion of each of the at least one mouth part; at least one sensor indicator which can be in communication with the controller; and a touch screen display interface which can be in communication with the controller and can be configured to display the detected each of the at least one motion of each of the at least one mouth part in real-time.

In an embodiment, the at least one sensor detector can be selected from the group consisting of a pressure sensor, a capacitive touch sensor, and a combination thereof.

In another embodiment, the kit can further include at least one sensor responder which can be configured to be placed on the at least one mouth part of the user, and each of the at least one sensor responder can be in communication with the controller via each of at least one sensor outlet port of the language training device.

In an additional embodiment, the touch screen display interface can be further configured to allow the user to select at least one language and at least one letter and/or at least one word for the corresponding selected at least one language.

In a supplementary embodiment, the language training device can further include: a power button which can be configured to turn on/off the language training device, a microphone which can be in communication with the controller and can be configured to capture a pronunciation of each of the at least one letter and/or each of the at least one word by the user, a speaker which can be in communication with the controller and can be configured to produce at least one peeping sound and/or at least one feedback from the language training device, a rechargeable battery which can be in communication with the controller and can be configured to power the language training device, and a USB port which can be in communication with the controller and can be configured to allow the user to update at least one transfer file and/or recharge the rechargeable battery.

In a further embodiment, the controller can be further configured to: detect the pronunciation of each of the at least one letter and/or the pronunciation of each of the at least one word, and determine if the detected pronunciation of each of the at least one letter and/or the detected pronunciation of each of the at least one word correspond to each of at least one predetermined correct pronunciation of each of the at least one letter and/or each of the at least one word, respectively.

In an embodiment, the controller can further include: a processor, a first internal memory chip which can be configured to store each of the at least one predetermined correct motion of each of the at least one mouth part, and a second internal memory chip which can be configured to store each of the at least one predetermined correct pronunciation of each of the at least one letter and/or at least one word.

In another embodiment, the processor can be configured to perform the steps of: (A) comparing the detected each of at least one motion of each of the at least one mouth part with each of the stored at least one predetermined correct motion of each of the at least one mouth part from the first internal memory chip, and (B) determining if the detected each of the at least one motion of each of the at least one mouth part correspond to each of the stored at least one predetermined correct motion of each of the at least one mouth part based on the comparison in step (A).

In an additional embodiment, the processor can be configured to perform the steps of: (C) comparing the detected pronunciation of each of the at least one letter and/or the detected pronunciation of each of the at least one word with each of the stored at least one predetermined correct pronunciation of each of the at least one letter and/or each of the at least one word, respectively, from the second internal memory chip, and (D) determining if the detected pronunciation of each of the at least one letter and/or the detected pronunciation of each of the at least one word correspond to each of the stored at least one predetermined correct pronunciation of each of the at least one letter and/or each of the at least one word, respectively, based on the comparison in step (C).

In a supplementary embodiment, the at least one sensor indicator can be configured to display at least one color light based on the determinations of steps B and D.

In an embodiment, the at least one sensor responder can be configured to vibrate based on the determinations of steps B and D.

In a further embodiment, the present subject matter relates to a method of using the above kit, wherein the method can include placing the at least one sensor detector on the at least one mouth part of the user; selecting at least one language and at least one letter and/or at least one word for the corresponding selected at least one language using the touch screen display interface; pronouncing each of the at least one letter and/or each of the at least one word by the user; a first detection step of detecting, by the controller as each of the at least one letter and/or each of the at least one word is being pronounced, each of the at least one motion of each of the at least one mouth part via each of the at least one sensor detector; a first determination step of determining if the detected each of the at least one motion of each of the at least one mouth part correspond to each of the at the least one predetermined correct motion of each of the at least one mouth part; and displaying the detected each of the at least one motion of each of the at least one mouth part in real-time on the touch screen display interface.

In an embodiment, the method can further include a second detection step of detecting the pronunciation of each of the at least one letter and/or the pronunciation of each of the at least one word via the controller, and a second determination step of determining if the detected pronunciation of each of the at least one letter and/or the detected pronunciation of each of the at least one word correspond to each of at least one predetermined correct pronunciation of each of the at least one letter and/or each of the at least one word, respectively.

In another embodiment, the first determination step can include the steps of: (A) comparing the detected each of at least one motion of each of the at least one mouth part with each of the stored at least one predetermined correct motion of each of the at least one mouth part from the first internal memory chip, and (B) determining if the detected each of the at least one motion of each of the at least one mouth part correspond to each of the stored at least one predetermined correct motion of each of the at least one mouth part based on the comparison of step (A).

In an additional embodiment, the second determination step can include the steps of: (C) comparing the detected pronunciation of each of the at least one letter and/or the detected pronunciation of each of the at least one word with each of the stored at least one predetermined correct pronunciation of each of the at least one letter and/or each of the at least one word, respectively, from the second internal memory chip, and (D) determining if the detected pronunciation of each of the at least one letter and/or the detected pronunciation of each of the at least one word correspond to each of the stored at least one predetermined correct pronunciation of each of the at least one letter and/or each of the at least one word, respectively, based on the comparison of step (C).

In a supplementary embodiment, the method can further include: when the detected each of the at least one motion of each of the at least one mouth part correspond to each of the stored at least one predetermined correct motion of each of the at least one mouth part, and when the detected pronunciation of each of the at least one letter and/or the detected pronunciation of each of the at least one word correspond to each of the stored at least one predetermined correct pronunciation of each of the at least one letter and/or each of the at least one word, displaying a green color light on each of the at least one sensor indicator; and producing at least one peeping sound and/or at least one feedback from the language training device via the speaker.

In a further embodiment, the method can further include: when the detected each of the at least one motion of each of the at least one mouth part does not correspond to each of the stored at least one predetermined correct motion of each of the at least one mouth part, and when the detected pronunciation of each of the at least one letter and/or the detected pronunciation of each of the at least one word does not correspond to each of the stored at least one predetermined correct pronunciation of each of the at least one letter and/or each of the at least one word, displaying a red color light on each of the at least one sensor indicator; and producing at least one feedback from the language training device via the speaker.

These and other features of the present subject matter will become readily apparent upon further review of the following specification.

### BRIEF DESCRIPTION OF DRAWINGS

The sole figure depicts a kit.

### DETAILED DESCRIPTION

The following definitions are provided for the purpose of understanding the present subject matter and for construing the appended patent claims. The definitions are not meant to be limiting to the subject matter described herein.

### Definitions

Throughout the application, where systems are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a system or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

The sole figure depicts, in an embodiment, a kit 100 which can include at least one sensor detector 105. The at least one sensor detector 105 can be configured to be placed on at least one mouth part (i.e., tongue, upper lip, lower lip, upper teeth, lower teeth) of a user.

In an embodiment, the at least one sensor detector 105 can be selected from the group consisting of a pressure sensor, a capacitive touch sensor, and a combination thereof. In a non-limiting embodiment, the at least one sensor detector 105 can include one or more pressure sensors and can be attached to the user's tongue 110 and/or upper lip 115 and/or lower lip 120 (hereinafter, the tongue 110 and/or upper lip 115 and/or lower lip 120 will be referred as “tull 110/115/120”) via biocompatible adhesive strips (not shown). The one or more pressure sensors can monitor the force applied by the user's tull 110/115/120 when the user pronounces at least one letter and/or at least one word for a particular language as described herein.

In another non-limiting embodiment, the at least one sensor detector 105 can include one or more capacitive sensors and can be attached to the user's teeth 125 (i.e., upper and/or lower teeth) via dental clips (not shown). The one or more capacitive sensors can detect proximity and contact of the tull 110/115/120 with respect to the teeth 125. In a further non-limiting embodiment, each of the one or more capacitive sensors can be integrated with a force sensor (not shown) or a pressure sensor (not shown) to detect the amount force or pressure applied to the teeth 125. While the one or more pressure sensors can be used for the user's tull 110/115/120 and the one or more capacitive sensors can be used for the user's teeth 125, it should be understood that the mentioned pressure and capacitive sensors can also be used for the teeth 125 and the tull 110/115/120, respectively, without departing from the present subject matter.

In an embodiment, the kit 100 can also include at least one sensor responder 130. The at least one sensor responder 130 can be configured to be placed on the at least one mouth part of the user. In certain non-limiting embodiments, the at least one sensor responder 130 can be attached to the user's tongue 110, upper lip 115, lower lip 120, and/or teeth 125 via the respective biocompatible adhesive strips and dental clips as mentioned above. In a particular non-limiting embodiment, the at least one sensor responder 130 can be a piezoelectric sensor for providing feedback through vibration to notify the user of incorrect positioning of the at least one mouth part as described herein. While the at least one sensor detector 105 and the at least one sensor responder 130 are shown in the sole figure as having circular and square shapes, respectively, it should be noted that all the mentioned sensors can have any shape without departing from the present subject matter.

The kit 100 can additionally include a language training device 135 which can include at least one sensor inlet port (140a, 140b, 140c, 140d, 140e, 140f, 140g, 140h, 140i, 140j), at least one sensor outlet port (145a, 145b, 145c, 145d, 145e, 145f, 145g, 145h, 145i, 145j), a controller (not shown), at least one sensor indicator 150, and a touch screen display interface 155.

In an embodiment, each of the at least one sensor inlet port (140a, 140b, 140c, 140d, 140e, 140f, 140g, 140h, 140i, 140j) can be in communication with one of each of the at least one sensor detector 105, respectively, via one of each of at least one first signal wire 160. Likewise, each of the at least one sensor outlet port (145a, 145b, 145c, 145d, 145e, 145f, 145g, 145h, 145i, 145j) can be in communication with one of each of the at least one sensor responder 130 via one of each of at least one second signal wire 165.

In an embodiment, the controller can be in communication with each of the at least one sensor detector 105 and each of the at least one sensor responder 130 via each of the at least one respective sensor inlet port (140a, 140b, 140c, 140d, 140e, 140f, 140g, 140h, 140i, 140j) and each of the at least one respective sensor outlet port (145a, 145b, 145c, 145d, 145e, 145f, 145g, 145h, 145i, 145j), respectively. It should be noted that the far right two sensor inlet ports (140i, 140j) and the far right two sensor outlet ports (145i, 145j) can be used for communicating each of the at least one sensor detector 105 (attached to the lower teeth which are not shown) and each of the at least one sensor responder 130 (attached to the lower teeth which are not shown) to the controller. The controller can be configured to detect each of at least one motion of each of the at least one mouth part via each of the at least one sensor detector 105 and determine if the detected each of the at least one motion of each of the at least one mouth part correspond to each of at least one predetermined correct motion (stored in a first internal memory chip) of each of the at least one mouth part as described herein. The controller can be a microprocessor or a microcontroller.

In an embodiment, the at least one sensor indicator 150 can be in communication with the controller. The at least one sensor indicator 150 can be configured to display at least one color light as described herein. The at least one color light can be selected from the group consisting of green color light, red color light, other colors light, and a combination thereof.

In an embodiment, the touch screen display interface 155 can be in communication with the controller and can be configured to display the detected each of the at least one motion of each of the at least one mouth part including visual cues and guidance on proper positioning of each of the at least one mouth part in real-time as described herein. In an embodiment, the touch screen display interface 155 can also be configured to allow the user to select at least one language and at least one letter and/or at least one word for the corresponding selected at least one language via physical selection (i.e., using a finger and/or thumb to make the selection on the touch screen display interface 155). According to this embodiment, the at least one language can be selected from the group consisting of Arabic, Afroasiatic, Sino-Tibetan, Austroasiatic, Albanian, Hebrew, Chinese, Vietnamese, Japanese, Korean, English, Pidgin, Haitian Creole, Spanish, Niger-Congo, Austronesian, Greek, Indo-European, Trans-New Guinea, Bengali, Dravidian, Jargon, French, Italian, Portuguese, Romanian, Rhaeto-Romansch, Danish, Faroese, Icelandic, Norwegian, Swedish, Afrikaans, Dutch, Flemish, Frisian, German, Yiddish, Czech, Polish, Slovak, Sorbian, Belarusian, Russian, Ukrainian, Bulgarian, Croatian, Macedonian, Serbian, Slovene, Latvian, Lithuanian, Breton, Welsh, Irish, Scots Gaelic, Armenian, Assamese, Bihari, Gujarati, Hindu-Urdu, Marathi, Punjabi, Romani, Sanskrit, Sindhi, Singhalese, Avestan, Balochi, Kurdish, Sogdian, other languages, and a combination thereof. The at least one language can include different dialects of the languages mentioned. The touch screen display interface 155 can further be configured to allow the user to turn on/off the vibration from the piezoelectric sensor.

The language training device 135 can further include a power button 170, a microphone 175, a rechargeable battery (not shown), a speaker 180, and a USB port 185.

In an embodiment, the power button 170 can be in communication with the controller and can be configured to turn on/off the language training device 135.

In an embodiment, the microphone 175 can be in communication with the controller and can be configured to capture a pronunciation of each of the at least one letter and/or each of the at least one word by the user as described herein. In an embodiment, the microphone 175 can also be configured to allow the user to select the at least one language and the at least one letter and/or at least one word for the corresponding selected at least one language via voice activation. According to this embodiment, the voice activated selection can cause the selected at least one language and the at least one letter and/or at least one word to be displayed on the touch screen display interface 155. Accordingly, the at least one language and the at least one letter and/or at least one word can be selected via voice activation or physical selection.

In an embodiment, the rechargeable battery can be in communication with the controller and can be configured to power the language training device 135.

In a further embodiment, the speaker 180 can be in communication with the controller and can be configured to produce at least one peeping sound and/or at least one feedback from the language training device 135 as described herein. In a particular non-limiting embodiment, the at least one feedback can be at least one of a plurality of incorrect positioning of the at least one mouth part prerecorded phrases. Such phrases can comprise but are not limited to one or more of: move your tongue slightly back, round your upper lip more, round your lower lip more, roll your tongue more, move your upper teeth away from your bottom teeth more, move your upper teeth closer to your bottom teeth, put your tongue between your top and bottom teeth, touch your tongue on the back of your front teeth and the top of your mouth, close your upper and lower lips, move your tongue in the middle of the mouth, other incorrect positioning of the at least one mouth part prerecorded phrases, and a combination thereof. Conversely, in some non-limiting embodiments, the at least one feedback can be at least one of a plurality of correct positioning of the at least one mouth part prerecorded phrases comprising one or more of: good job, congratulations you did it, keep up the good work, other correct positioning of the at least one mouth part prerecorded phrases, and a combination thereof. In an embodiment, the volume control and the turn on/off function of the speaker 180 can be controlled via the touch screen display interface 155.

In an embodiment, the USB port 185 can be in communication with the controller and can be configured to allow the user to update at least one transfer file and/or recharge the rechargeable battery. In an embodiment, the at least one transfer file can be the at least one language (i.e., the at least one language can be the Arabic language and/or at least one of the above-mentioned language including different dialects thereof) with the corresponding at least one letter and/or at least one word. The at least one transfer file can be sent to the controller for updating the at least one language with the corresponding at least one letter and/or at least one word. In this context, the controller can store a plurality of languages with the corresponding at least one letter and/or at least one word simultaneously. In another embodiment, the at least one transfer file, which can be sent to the controller, can also include gender voice selection and practice logs for progress tracking and analysis (i.e., allow the user to hear playback of previous attempts of pronouncing the at least one letter and/or at least one word). Corresponding to this embodiment, the user can change the current gender voice prompt on the language training device 135 to a desired selected gender voice (i.e., from male to female or vise versa) via the touch screen display interface 155. The desired selected gender voice prompt and the current gender voice prompt can verbally read out the at least one feedback via the speaker 180.

In an embodiment, the above controller can further include a first internal memory chip (not shown), a second internal memory chip, and a processor (not shown). The first internal memory chip can be configured to store each of at least one predetermined correct motion of each of the at least one mouth part. The second internal memory chip can be configured to store each of at least one predetermined correct pronunciation of each of the at least one letter and/or at least one word.

In a further embodiment, the above controller can be further configured to: detect the pronunciation of each of the at least one letter and/or the pronunciation of each of the at least one word, and determine if the detected pronunciation of each of the at least one letter and/or the detected pronunciation of each of the at least one word correspond to each of the at least one predetermined correct pronunciation of each of the at least one letter and/or each of the at least one word, respectively, stored in the second internal memory chip.

In an embodiment, the processor can be configured to perform the steps of: (A) comparing the detected each of at least one motion of each of the at least one mouth part with each of the stored at least one predetermined correct motion of each of the at least one mouth part from the first internal memory chip, and (B) determining if the detected each of the at least one motion of each of the at least one mouth part correspond to each of the stored at least one predetermined correct motion of each of the at least one mouth part based on the comparison in step (A).

In an embodiment, the processor can also be configured to perform the steps of: (C) comparing the detected pronunciation of each of the at least one letter and/or the detected pronunciation of each of the at least one word with each of the stored at least one predetermined correct pronunciation of each of the at least one letter and/or each of the at least one word, respectively, from the second internal memory chip, and (D) determining if the detected pronunciation of each of the at least one letter and/or the detected pronunciation of each of the at least one word correspond to each of the stored at least one predetermined correct pronunciation of each of the at least one letter and/or each of the at least one word, respectively, based on the comparison in step (C).

In an embodiment, the at least one sensor indicator 150 and the at least one sensor responder 130 can be configured to display at least one color and vibrate, respectively, based on the determinations of steps B and D as described herein.

In a further embodiment, the present subject matter relates to a method of using the above kit 100 for facilitating correct pronunciation of at least one letter and/or at least one word for a particular language. In a non-limiting embodiment, the method can be useful for learning languages that have unique pronunciations which necessitate deliberate learning (i.e., when an English-speaking individual learns to pronounce at least one unique letter and/or at least one unique word of the Arabic language). The method can begin with placing the at least one sensor detector 105 on the at least one mouth part (i.e., tongue 110, upper lip 115, lower lip 120, and/or teeth 125 (upper and/or lower teeth)) of the user (Step 1). In a non-limiting example, the at least one sensor responder 130 can be placed in the vicinity of the at least one sensor detector 105 on the same at least one mouth part (Step 2).

Then, the touch screen display interface 155 can prompt the user to select at least one language and at least one letter and/or at least one word for the corresponding selected at least one language (Step 3). In this regard, the user can physically select the at least one language and the corresponding at least one letter and/or at least one word via the touch screen display interface 155 (i.e., using a finger and/or thumb to make the selection on the touch screen display interface 155). Conversely, the user can select the at least one language and the corresponding at least one letter and/or at least one word by speaking through the microphone 175. According to this embodiment, the voice activated selection can be displayed on the touch screen display interface 155. As a non-limiting example, the prompt from the touch screen display interface 155 can be exclusively displayed on the touch screen display interface 155, displayed on the touch screen display interface 155 and verbally dictated via the speaker 180, or exclusively verbally dictated via the speaker 180 (hereinafter, all the various prompt options mentioned will be referred as “prompt options”).

Next, the touch screen display interface 155 can prompt (via the prompt options) the user to pronounces, via the microphone 175, each of the at least one letter and/or each of the at least one word selected (Step 4). In this aspect, as each of the at least one letter and/or each of the at least one word is being pronounced by the user, the controller can perform a first detection step of detecting each of the at least one motion of each of the at least one mouth part via each of the at least one sensor detector 105 (Step 5). Afterward, the controller can perform a first determination step of determining if the detected each of the at least one motion of each of the at least one mouth part correspond to each of the at the least one predetermined correct motion of each of the at least one mouth part (Step 6). According to this embodiment, the processor, which is part of the controller, can perform the first determination step which can include the step (A) of comparing the detected each of at least one motion of each of the at least one mouth part with each of the stored at least one predetermined correct motion of each of the at least one mouth part from the first internal memory chip (Step 7). Thereafter, the processor can further perform an additional first determination step which can include a step (B) of determining if the detected each of the at least one motion of each of the at least one mouth part correspond to each of the stored at least one predetermined correct motion of each of the at least one mouth part based on the comparison of step (A) (Step 8).

The controller can also perform a second detection step of detecting the pronunciation of each of the at least one letter and/or the pronunciation of each of the at least one word (Step 9). Subsequently, the controller can perform a second determination step of determining if the detected pronunciation of each of the at least one letter and/or the detected pronunciation of each of the at least one word correspond to each of at least one predetermined correct pronunciation of each of the at least one letter and/or each of the at least one word, respectively (Step 10). In this respect, the processor can perform the second determination step which can include the step (C) of comparing the detected pronunciation of each of the at least one letter and/or the detected pronunciation of each of the at least one word with each of the stored at least one predetermined correct pronunciation of each of the at least one letter and/or each of the at least one word, respectively, from the second internal memory chip (Step 11). Following, the processor can further perform an additional second determination step which can include a step (D) of determining if the detected pronunciation of each of the at least one letter and/or the detected pronunciation of each of the at least one word correspond to each of the stored at least one predetermined correct pronunciation of each of the at least one letter and/or each of the at least one word, respectively, based on the comparison of step (C) (Step 12).

While the detection and determination steps of the at least one motion of each of the at least one mouth part (Steps 5-8) and the pronunciation of each of the at least one letter and/or the at least one word (Steps 9-12) have described as being a first step and a second step, respectively, it should be understood that the respective detection and determination steps can occur in any order, without departing from the present subject matter.

In an embodiment, the determination of steps B and D (Steps 8 and 12, respectively) as mentioned above can be evaluated by the processor. In this aspect, when all of the detected each of the at least one motion of each of the at least one mouth part correspond to each of the stored at least one predetermined correct motion of each of the at least one mouth part (condition A1) and when all of the detected pronunciation of each of the at least one letter and/or the detected pronunciation of each of the at least one word correspond to each of the stored at least one predetermined correct pronunciation of each of the at least one letter and/or each of the at least one word (condition A2), the processor can generate and assign all true logics to all of the detected each of the at least one motion of each of the at least one mouth part (Step 13).

Conversely, in another embodiment, when all of the detected each of the at least one motion of each of the at least one mouth part does not correspond to each of the stored at least one predetermined correct motion of each of the at least one mouth part (condition B1) and when all of the detected pronunciation of each of the at least one letter and/or the detected pronunciation of each of the at least one word does not correspond to each of the stored at least one predetermined correct pronunciation of each of the at least one letter and/or each of the at least one word (condition B2), the processor can generate and assign all false logics to all of the detected each of the at least one motion of each of the at least one mouth part (Step 14).

In an alternative embodiment, when one or more but less than all of the detected each of the at least one motion of each of the at least one mouth part correspond to each of the stored at least one predetermined correct motion of each of the at least one mouth part (condition C1) and when one or more but less than all of the detected pronunciation of each of the at least one letter and/or the detected pronunciation of each of the at least one word correspond to each of the stored at least one predetermined correct pronunciation of each of the at least one letter and/or each of the at least one word (condition C2), the processor can generate and assign a true logic and a false logic to each of the at least one mouth part satisfying condition C1 and not satisfying condition C1, respectively (Step 15). According to this embodiment, as a non-limiting example, when only the detected motions of the user's tongue 110, upper lip 115, and lower lip 120 correspond to each of the stored at least one predetermined correct motion of the tongue 110, upper lip 115, and lower lip 120 (i.e., detected motion of the user's teeth 125 does not correspond to the stored predetermined correct motion of the teeth 125) and when one or more but less than all of the detected pronunciation of each of the at least one letter and/or the detected pronunciation of each of the at least one word correspond to each of the stored at least one predetermined correct pronunciation of each of the at least one letter and/or each of the at least one word, the processor can generate and assign a true logic for the tongue 110, the upper lip 115, and the lower lip 120 and generate and assign a false logic for the teeth 125. It should be noted that any combination of the user's mouth parts can correspond to each of the stored at least one predetermined correct motion (i.e., detected motion(s) of the user's tongue 110 and/or upper lip 115 and/or lower lip 120 and/or teeth 125 (upper and/or lower teeth) can correspond to each of the stored at least one predetermined correct motion of the tongue 110 and/or upper lip 115 and/or lower lip 120 and/or teeth 125 (upper and/or lower teeth)) without departing from the present subject matter. This also applies to step 16 as described herein.

In another alternative embodiment, when one or more but less than all of the detected each of the at least one motion of each of the at least one mouth part does not correspond to each of the stored at least one predetermined correct motion of each of the at least one mouth part (condition D1) and when one or more but less than all of the detected pronunciation of each of the at least one letter and/or the detected pronunciation of each of the at least one word does not correspond to each of the stored at least one predetermined correct pronunciation of each of the at least one letter and/or each of the at least one word (condition D2), the processor can generate and assign a false logic and a true logic to each of the at least one mouth part satisfying condition D1 and not satisfying condition D1, respectively (Step 16). According to this embodiment, as another non-limiting example, when only the detected motions of the user's tongue 110, upper lip 115, and lower lip 120 does not correspond to each of the stored at least one predetermined correct motion of the tongue 110, upper lip 115, and lower lip 120 (i.e., detected motion of the user's teeth 125 correspond to the stored predetermined correct motion of the teeth 125) and when one or more but less than all of the detected pronunciation of each of the at least one letter and/or the detected pronunciation of each of the at least one word does not correspond to each of the stored at least one predetermined correct pronunciation of each of the at least one letter and/or each of the at least one word, the processor can generate false logic for the tongue 110, the upper lip 115, and the lower lip 120 and generate true logic for the teeth 125.

Referring back to step 13, when the processor generates all true logics, the controller can cause each of the at least one sensor indicator 150 to display a green color light (Step 17). Simultaneously or concurrently with step 17, the controller can cause the speaker 180 to produce at least one peeping sound and/or at least one feedback from the language training device 135 (Step 18). The at least one feedback can be at least one of the plurality of correct positioning of the at least one mouth part prerecorded phrases (Step 18). In an embodiment, the controller can cause, simultaneously or concurrently with step 17 and/or step 18, the touch screen display interface 155 to display the detected each of the at least one motion of each of the at least one mouth part in real-time (Step 19). In this context, the touch screen display interface 155 can have an animated replica of a human's mouth parts (tongue, upper lip, lower lip, upper teeth, and lower teeth). Each of the animated replica mouth parts can move in real-time corresponding to the motions of each of the respective tongue 110, upper lip 115, lower lip 120, and teeth 125 (upper and lower teeth) via each signal from each of the at least one sensor detector 105 (Step 19). As another non-limiting example, each of the animated replica mouth parts (tongue, upper lip, lower lip, upper teeth, and lower teeth) can be displayed in green color (Step 20).

Referring back to step 14, when the processor generates all false logics, the controller can cause each of the at least one sensor responder 130 to vibrate (Step 21). Simultaneously or concurrently with step 21, the controller can cause each of the at least one sensor indicator 150 to display a red color light (Step 22). Simultaneously or concurrently with step 21 and/or step 22, the controller can cause the speaker 180 to produce at least one feedback from the language training device 135 (Step 23). The at least one feedback can be at least one of the plurality of incorrect positioning of the at least one mouth part prerecorded phrases (Step 23). In an embodiment, the controller can cause, simultaneously or concurrently with step 21 and/or step 22 and/or step 23, the touch screen display interface 155 to display the detected each of the at least one motion of each of the at least one mouth part in real-time (Step 24). In this context, each of the animated replica mouth parts (tongue, upper lip, lower lip, upper teeth, and lower teeth) can move in real-time corresponding to the motions of the respective tongue 110, upper lip 115, lower lip 120, and teeth 125 (upper and lower teeth) via each signal from each of the at least one sensor detector 105 (Step 24). In a non-limiting embodiment, each of the animated replica mouth parts (tongue, upper lip, lower lip, upper teeth, and lower teeth) can be displayed in red color (Step 25).

In an embodiment, once the user makes all the proper adjustments based on the at least one of the plurality of incorrect positioning of the at least one mouth part prerecorded phrases and when the processor generates all true logics as indicated in step 13, each of the at least one sensor responder 130 (see Step 21) can stop vibrating and the above steps 17-19 can occur (Step 26).

Referring back to step 15, when the processor generates and assign a true logic and a false logic to each of the at least one mouth part satisfying condition C1 and not satisfying condition C1, respectively, the controller can cause each of the at least one sensor indicator 150 (corresponding to each of the one or more but less than all of the detected each of the at least one motion of each of the at least one mouth part satisfying condition C1) to display a green color light and can cause each of the at least one sensor indicator 150 (corresponding to each of the detected each of the at least one motion of each of the at least one mouth part not satisfying condition C1) to display a red color light (Step 27). According to this embodiment, the controller can cause each of the at least one sensor responder 130 (corresponding to each of the detected each of the at least one motion of each of the at least one mouth part not satisfying condition C1) to vibrate (Step 28).

In this context and by way of a non-limiting illustration, as referenced to the non-limiting example of step 15, the processor can generate and assign a true logic for each of the tongue 110, the upper lip 115, and the lower lip 120 and generate and assign a false logic for the teeth 125. The controller can cause each of the at least one sensor responder 130 corresponding to the teeth 125 to vibrate. Simultaneously or concurrently with step 27 and/or step 28, the controller can cause the speaker 180 to produce at least one feedback from the language training device 135 (Step 29). The at least one feedback can be one of the at least one of the plurality of incorrect positioning of the at least one mouth part prerecorded phrases corresponding to the generated and assigned false logic (i.e., that would be teeth 125 for the example mentioned above).

In an embodiment, the controller can cause, simultaneously or concurrently with step 27 and/or step 28 and/or step 29, the touch screen display interface 155 to display the detected each of the at least one motion of each of the at least one mouth part in real-time (Step 30). In this context, each of the animated replica mouth parts (tongue, upper lip, lower lip, upper teeth, and lower teeth) can move in real-time corresponding to the motions of the respective tongue 110, upper lip 115, lower lip 120, and teeth 125 (upper and lower teeth) of the user via each signal from each of the at least one sensor detector 105 (Step 31). In another non-limiting embodiment, each of the respective animated replica mouth parts can be displayed in green color if each of the corresponding respective tongue 110, upper lip 115, lower lip 120, and teeth 125 (upper and lower teeth) of the user are assigned a true logic by the processor (Step 32).

Referring back to the above non-limiting illustration in step 15, each of the animated replica mouth parts (tongue, upper lip, lower lip) can be displayed in green color since each of the user's tongue 110, the upper lip 115, and the lower lip 120 are assigned a true logic. Similarly, the animated replica mouth part (upper and lower teeth) can be displayed in red color since the user's teeth 125 (upper and lower teeth) are assigned a false logic.

In an embodiment, once the user makes all the proper adjustments based on the at least one of the plurality of incorrect positioning of the at least one mouth part prerecorded phrases and when the processor generates all true logics as indicated in step 13, each of the at least one sensor responder 130 (see Step 28) can stop vibrating and the above steps 17-20 can occur (Step 33).

Referring back to step 16, when the processor generates and assign a false logic and a true logic to each of the at least one mouth part satisfying condition D1 and not satisfying condition D1, respectively, the controller can cause each of the at least one sensor indicator 150 (corresponding to each of the one or more but less than all of the detected each of the at least one motion of each of the at least one mouth part satisfying condition D1) to display a red color light and can cause each of the at least one sensor indicator 150 (corresponding to each of the detected each of the at least one motion of each of the at least one mouth part not satisfying condition D1) to display a green color light (Step 34). According to this embodiment, the controller can cause each of the at least one sensor responder 130 (corresponding to each of the detected each of the at least one motion of each of the at least one mouth part satisfying condition D1) to vibrate (Step 35). In this context and by way of another non-limiting illustration, as referenced to the non-limiting example of step 16, the processor can generate and assign a false logic for each of the tongue 110, the upper lip 115, and the lower lip 120 and generate and assign a true logic for the teeth 125. Simultaneously or concurrently with step 34 and/or step 35, the controller can cause the speaker 180 to produce at least one feedback from the language training device 135 (Step 36). The at least one feedback can be at least one of the plurality of incorrect positioning of the at least one mouth part prerecorded phrases corresponding to the generated and assigned false logic (i.e., that would be the tongue 110, the upper lip 115, and the lower lip 120 for the example mentioned above).

In an embodiment, the controller can cause, simultaneously or concurrently with step 34 and/or step 35, the touch screen display interface 155 to display the detected each of the at least one motion of each of the at least one mouth part in real-time (Step 36). In this context, each of the animated replica mouth parts (tongue, upper lip, lower lip, upper teeth, and lower teeth) can move in real-time corresponding to each of the motions of the respective tongue 110, upper lip 115, lower lip 120, and teeth 125 (upper and lower teeth) of the user via each signal from each of the at least one sensor detector 105 (Step 37). In another non-limiting embodiment, each of the respective animated replica mouth parts can be displayed in red color if each of the corresponding respective tongue 110, upper lip 115, lower lip 120, and teeth 125 (upper and lower teeth) of the user are assigned a false logic by the processor (Step 38).

Referring back to the above another non-limiting illustration, each of the animated replica mouth parts (tongue, upper lip, lower lip) can be displayed in red color since each of the tongue 110, the upper lip 115, and the lower lip 120 of the user are assigned a false logic. Similarly, the animated replica mouth part (upper and lower teeth) can be displayed in green color since the teeth 125 (upper and lower teeth) of the user are assigned a true logic.

In an embodiment, once the user makes all the proper adjustments based on the at least one of the plurality of incorrect positioning of the at least one mouth part prerecorded phrases and when the processor generates all true logics as indicated in step 13, each of the at least one sensor responder 130 (see Step 35) can stop vibrating and the above steps 17-20 can occur (Step 39).

It is to be understood that the kit and the method of using the kit are not limited to the specific embodiments described above, but encompass any and all embodiments within the scope of the generic language of the following claims enabled by the embodiments described herein, or otherwise shown in the drawings or described above in terms sufficient to enable one of ordinary skill in the art to make and use the claimed subject matter.

1. A kit comprising:
at least one sensor detector configured to be placed on at least one mouth part of a user;
wherein the at least one sensor detector comprises:
a first sensor detector configured to be placed on an upper lip of the user;
a second sensor detector configured to be placed on a lower lip of the user;
a third sensor detector configured to be placed on upper teeth of the user;
a fourth sensor detector configured to be placed on lower teeth of the user; and
a fifth sensor detector configured to be placed on a tongue of the user; and
a language training device comprising:
at least one sensor inlet port, wherein each of the at least one sensor inlet port is in communication with one of each of the at least one sensor detector, respectively;
a controller in communication with each of the at least one sensor detector via each of the at least one respective sensor inlet port, wherein the controller is configured to separately detect each of at least one motion of each of the at least one mouth part via each of the at least one sensor detector and to separately determine if the detected each of the at least one motion of each of the at least one mouth part correspond to each of at least one predetermined correct motion of each of the at least one mouth part;
at least one sensor indicator in communication with the controller; and
a touch screen display interface in communication with the controller and configured to display the detected each of the at least one motion of each of the at least one mouth part in real-time,
wherein the at least one motion of each of the at least one mouth part corresponds to an oral motor skill that produces a speech sound, and
wherein the at least one predetermined correct motion of each of the at least one mouth part corresponds to an oral motor skill that produces a correct speech sound in a language.

2. The kit of claim 1, wherein the at least one sensor detector is selected from the group consisting of a pressure sensor, a capacitive touch sensor, and a combination thereof.

3. The kit of claim 1, further comprising:
at least one sensor responder configured to be placed on the at least one mouth part of the user,
wherein each of the at least one sensor responder is in communication with the controller via each of at least one sensor outlet port of the language training device.

4. The kit of claim 3, wherein the touch screen display interface is further configured to allow the user to select at least one language and at least one letter and/or at least one word for the corresponding selected at least one language.

5. The kit of claim 4, wherein the language training device further comprises:
a power button configured to turn on/off the language training device,
a microphone in communication with the controller and configured to capture a pronunciation of each of the at least one letter and/or each of the at least one word by the user,
a speaker in communication with the controller and configured to produce at least one peeping sound and/or at least one feedback from the language training device,
a rechargeable battery in communication with the controller and configured to power the language training device, and
a USB port in communication with the controller and configured to allow the user to update at least one transfer file and/or recharge the rechargeable battery.

6. The kit of claim 5, wherein the controller is further configured to:
detect the pronunciation of each of the at least one letter and/or the pronunciation of each of the at least one word, and
determine if the detected pronunciation of each of the at least one letter and/or the detected pronunciation of each of the at least one word correspond to each of at least one predetermined correct pronunciation of each of the at least one letter and/or each of the at least one word, respectively.

7. The kit of claim 6, wherein the controller further comprises:
a processor,
a first internal memory chip configured to store each of the at least one predetermined correct motion of each of the at least one mouth part, and
a second internal memory chip configured to store each of the at least one predetermined correct pronunciation of each of the at least one letter and/or at least one word.

8. The kit of claim 7, wherein the processor is configured to perform the steps of:
(A) comparing the detected each of at least one motion of each of the at least one mouth part with each of the stored at least one predetermined correct motion of each of the at least one mouth part from the first internal memory chip, and
(B) determining if the detected each of the at least one motion of each of the at least one mouth part correspond to each of the stored at least one predetermined correct motion of each of the at least one mouth part based on the comparison in step (A).

9. The kit of claim 8, wherein the processor is configured to perform the steps of:
(C) comparing the detected pronunciation of each of the at least one letter and/or the detected pronunciation of each of the at least one word with each of the stored at least one predetermined correct pronunciation of each of the at least one letter and/or each of the at least one word, respectively, from the second internal memory chip, and
(D) determining if the detected pronunciation of each of the at least one letter and/or the detected pronunciation of each of the at least one word correspond to each of the stored at least one predetermined correct pronunciation of each of the at least one letter and/or each of the at least one word, respectively, based on the comparison in step (C).

10. The kit of claim 9, wherein the at least one sensor indicator is configured to display at least one color light based on the determinations of steps B and D.

11. The kit of claim 10, wherein the at least one sensor responder is configured to vibrate based on the determinations of steps B and D.

12. A method of using the kit of claim 1, the method comprising:
placing each of the at least one sensor detector on each of the at least one mouth part of the user;
selecting at least one language and at least one letter and/or at least one word for the corresponding selected at least one language using the touch screen display interface;
pronouncing each of the at least one letter and/or each of the at least one word by the user;
a first detection step of separately detecting, by the controller as each of the at least one letter and/or each of the at least one word is being pronounced, each of the at least one motion of each of the at least one mouth part via each of the at least one sensor detector;
a first determination step of separately determining if the detected each of the at least one motion of each of the at least one mouth part correspond to each of the at the least one predetermined correct motion of each of the at least one mouth part; and
displaying the detected each of the at least one motion of each of the at least one mouth part in real-time on the touch screen display interface,
wherein the at least one motion of each of the at least one mouth part corresponds to an oral motor skill that produces a speech sound, and
wherein the at least one predetermined correct motion of each of the at least one mouth part corresponds to an oral motor skill that produces a correct speech sound in a language.

13. The method of claim 12, further comprising:
placing at least one sensor responder on the at least one mouth part of the user, and wherein each of the at least one sensor responder is in communication with the controller via each of at least one sensor outlet port of the language training device.

14. The method of claim 13, wherein the language training device further comprises:
a power button configured to turn on/off the language training device,
a microphone in communication with the controller and configured to capture the pronunciation of each of the at least one letter and/or each of the at least one word by the user,
a speaker in communication with the controller and configured to produce at least one peeping sound and/or at least one feedback from the language training device,
a rechargeable battery in communication with the controller and configured to power the language training device, and
a USB port in communication with the controller and configured to allow the user to update at least one transfer file and recharge the rechargeable battery.

15. The method of claim 14, further comprising:
a second detection step of detecting the pronunciation of each of the at least one letter and/or the pronunciation of each of the at least one word via the controller, and
a second determination step of determining if the detected pronunciation of each of the at least one letter and/or the detected pronunciation of each of the at least one word correspond to each of at least one predetermined correct pronunciation of each of the at least one letter and/or each of the at least one word, respectively.

16. The method of claim 15, wherein the controller further comprises:
a processor,
a first internal memory chip configured to store each of the at least one predetermined correct motion of each of the at least one mouth part, and
a second internal memory chip configured to store each of the at least one predetermined correct pronunciation of each of the at least one letter and/or at least one word.

17. The method of claim 16, wherein the first determination step comprises the steps of:
(A) comparing the detected each of at least one motion of each of the at least one mouth part with each of the stored at least one predetermined correct motion of each of the at least one mouth part from the first internal memory chip, and
(B) determining if the detected each of the at least one motion of each of the at least one mouth part correspond to each of the stored at least one predetermined correct motion of each of the at least one mouth part based on the comparison of step (A).

18. The method of claim 17, wherein the second determination step comprises the steps of:
(C) comparing the detected pronunciation of each of the at least one letter and/or the detected pronunciation of each of the at least one word with each of the stored at least one predetermined correct pronunciation of each of the at least one letter and/or each of the at least one word, respectively, from the second internal memory chip, and
(D) determining if the detected pronunciation of each of the at least one letter and/or the detected pronunciation of each of the at least one word correspond to each of the stored at least one predetermined correct pronunciation of each of the at least one letter and/or each of the at least one word, respectively, based on the comparison of step (C).

19. The method of claim 18, further comprising:
wherein when the detected each of the at least one motion of each of the at least one mouth part correspond to each of the stored at least one predetermined correct motion of each of the at least one mouth part, and
wherein when the detected pronunciation of each of the at least one letter and/or the detected pronunciation of each of the at least one word correspond to each of the stored at least one predetermined correct pronunciation of each of the at least one letter and/or each of the at least one word,
displaying a green color light on each of the at least one sensor indicator; and
producing at least one peeping sound and/or at least one feedback from the language training device via the speaker.

20. The method of claim 18, further comprising:
wherein when the detected each of the at least one motion of each of the at least one mouth part does not correspond to each of the stored at least one predetermined correct motion of each of the at least one mouth part, and
wherein when the detected pronunciation of each of the at least one letter and/or the detected pronunciation of each of the at least one word does not correspond to each of the stored at least one predetermined correct pronunciation of each of the at least one letter and/or each of the at least one word,
displaying a red color light on each of the at least one sensor indicator; and
producing at least one feedback from the language training device via the speaker.
